(19) United States
(12) Patent Application Publication
(10) Pub. No.: US 2025/0221558 A1
(43) Pub. Date: Jul. 10, 2025

(54) DETACHABLE CARPET MAT

(71) Applicant: QINGDAO VANKING LIVING CO.,LTD., Qingdao (CN)

(72) Inventor: YOUPING DU, Qingdao (CN)

(21) Appl. No.: 18/404,245

(22) Filed: Jan. 4, 2024

(51) Int. Cl. A47G 27/02; B32B 5/02; B32B 5/18; B32B 5/24; B32B 5/26; B32B 7/12

(52) U.S. Cl. CPC A47G 27/025; A47G 27/0281; B32B 5/022; B32B 5/024; B32B 5/026; B32B 5/18; B32B 5/245; B32B 5/2795; B32B 7/12; B32B 2255/02; B32B 2266/0214; B32B 2307/744; B32B 2471/04

(57) ABSTRACT

A detachable carpet mat, where raised monofilaments and fleeces are bent through a high temperature to form a hooking-connecting effect with a first water-repellent anti-slip layer placed below the monofilaments and the fleeces, resulting in better bonding capacity, greater friction force and better firmness. Melted and solidified through the high temperature, the monofilaments and fibers of a hooking layer are not prone to falling off; the monofilaments of the hooking layer have a certain curvature and surfaces of small bumps of piles are passivated so as to prevent users from accidentally hurting their hands, and at the same time, enhance the locking effect with the first water-repellent anti-slip layer below.

### TECHNICAL FIELD

The present disclosure relates to the technical field of household products, in particular to a detachable carpet mat.

### BACKGROUND

A current design method of standard carpet mat type household products is to bond an anti-slip material to a back of a carpet mat. This is claimed to be washable, but will be separated or broken once washed in a machine, or an upper fabric and a lower bottom are separated. Moreover, the design and manufacturing of traditional mats or carpets are cumbersome and expensive, which hinders the versatility of such carpet mat type household products. For example, it does not allow users to replace them seasonally as needed. Therefore, there is a need for a carpet mat type household product that not only has a function of a conventional carpet mat type product, but also facilitates the users to separate a face material of the carpet mat from a liner layer with anti-slip and water-repellent properties so that the face material of the carpet mat household product is washed.

In the prior art, there is a composite carpet mat product that uses Velcro to connect a surface of the carpet mat type product and a liner. Velcro uses two sides to connect two layers of structures together. One side of the Velcro is composed of small and soft fiber loops, the other side is harder bristle with hooks, and the two sides are quite firm in bonding. A larger force is needed to separate them, because a pulling force to separate the two will be relatively large; and therefore, Velcro is used to connect the surface and the liner of the carpet mat. For a soft carpet mat, a large action force is likely to cause damage to the carpet mat, and disassembly is inconvenient. A harder side of Velcro will also reduce the use comfort of carpet mat type products. Moreover, the velcro or gravel-like cushions have a great destructive effect on soft loop velvet, and connection force is greatly reduced after repeated use.

### SUMMARY

A main objective of the present disclosure is to provide a detachable carpet mat that can effectively solve the problems in the background art.

In order to achieve the above objective, a technical solution adopted for the present disclosure is as follows:
the present disclosure provides a detachable carpet mat, which includes a surface layer and an adhesive anti-slip layer, wherein the carpet surface layer and the adhesive anti-slip layer are detachably connected;
the surface layer includes: a face layer and a hooking layer, and the face layer is set at the top end of the surface layer;
raised monofilaments are distributed on a lower surface of the hooking layer, after heat treatment, top ends of the raised monofilaments melt/soften, forming small lumps. At the same time, the monofilaments have a certain curvature and inclination after heat treatment to form hooks, and the hooks may be hooked to gaps of various adhesive anti-slip layers below and form a locking effect.

Preferably, the face layer includes a fleece fabric structure layer, a woven fabric layer with a mesh gap structure, a fabric structure layer with several gaps, a non-woven structure layer, and an air layer sandwich structure layer.

Preferably, a height of the raised monofilament is 0.5 mm to 5 mm. A thickness of the raised monofilament is 20DTEX to 5000DTEX.

Preferably, the adhesive anti-slip layer includes: a hooking-connecting face layer and a first anti-slip layer, and the first anti-slip layer is arranged at a bottom of the adhesive anti-slip layer.

Preferably, the hooking-connecting face layer and the first anti-slip layer are combined through glue or flame.

Preferably, a material of the first anti-slip layer adopts a thermoplastic elastomer layer, an EVA/PU/PVC/SBR/XPE foam material layer, a non-woven fabric layer, a hot melt glue layer, and a fabric layer with an anti-slip function.

Preferably, a supportive fabric structure layer is placed between the booking-connecting face layer and the first anti-slip layer. The supportive fabric structure layer includes a non-woven fabric layer, a sponge layer, a knitted layer and a woven layer. The supportive fabric structure layer can improve its support, dimensional stability, comfort and smoothness.

The hooks can be hooked even if the hooks are short, and the monofilaments do not need to extend too deeply into the hooking-connecting face layer, and the adhesive anti-slip layer may also be thinner. During use, the force on the surface layer will compress the carpet mat, which causes the hooks formed by the raised monofilaments on the surface layer to enter the adhesive anti-slip layer, resulting in a better hooking effect compared with non-bent monofilaments. The raised monofilaments are distributed on a back of the surface layer, which will not damage the surface layer during the disassembly process and has a long service life. Compared with the hooks being distributed on an upper surface of the adhesive anti-slip layer, it can be applied to an ultra-thin carpet mat surface and gives people a different touch. The raised monofilaments of the present disclosure will not pierce the surface layer, nor affect the use feeling. When replacing the surface layer on a large area, the adhesive anti-slip layer as a base may be reserved and used as a carpet mat for subsequent laying of the surface layer, the bumps all over a surface of the base will not prickle the hands, nor affect the replacement of the surface layer on the adhesive anti-slip layer.

Compared with the prior art, the present disclosure has the following beneficial effects.
1. The present disclosure uses the high temperature to bend the raised monofilaments and fleeces so as to form a hooking-connecting effect with the first water-repellent anti-slip layer placed below the monofilaments and the fleece surface, resulting in better bonding capacity, greater friction force and better firmness.
2. The present disclosure uses the high temperature for melting and solidifying, so that the monofilaments and fibers of the hooking layer are not prone to falling off.
3. The monofilaments of the hooking layer of the present disclosure have a certain curvature and the surfaces of the small bumps of piles are passivated so as to prevent the users from accidentally hurting their hands, and at the same time, enhance the locking effect with the first water-repellent anti-slip layer below.

### BRIEF DESCRIPTION OF DRAWINGS

FIG. 1 is a diagram of Embodiment 1 of the present disclosure;

FIG. 2 is a diagram of Embodiment 2 of the present disclosure; and

FIG. 3 is a diagram of Embodiment 3 of the present disclosure.

In the drawings: 1. plain woven structure face layer; 2. hooking layer; 3. hooking-connecting face layer; 4. first anti-slip layer; 5. fabric binding layer; 6. single-sided fleece structure layer; 7. mid-cotton layer; 8. non-woven fabric layer.

### DESCRIPTION OF EMBODIMENTS

### Embodiment 1

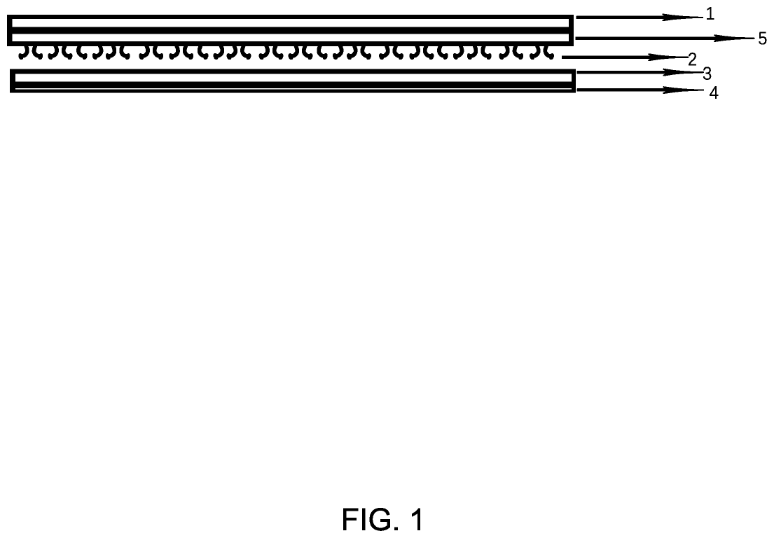

As shown in FIG. 1, the surface layer includes a plain woven structure face layer 1, a hooking layer 2 and a fabric binding layer 5. The plain woven structure layer 1 is connected to the fabric binding layer 5 through glue, then the fabric binding layer 5 and the hooking layer 2 are connected through glue, and the adhesive anti-slip layer includes a hooking-connecting face layer 3 and an anti-slip layer 4. The plain woven structure face layer 1 is arranged at a top end of the surface layer, and the hooking-connecting face layer 3 is bonded to a top end of the anti-slip layer 4. A supportive fabric structure layer is placed between the hooking-connecting face layer 3 and the first anti-slip layer 4. The supportive fabric structure layer includes a non-woven fabric layer, a sponge layer, a knitted layer and a woven layer. The supportive fabric structure layer can improve its support, dimensional stability, comfort and smoothness. A material of the first anti-slip layer 4 adopts a thermoplastic elastomer layer, an EVA/PU/PVC/SBR/XPE foam material layer, a non-woven fabric layer, a hot melt glue layer, and a fabric layer with an anti-slip function.

Raised monofilaments are distributed on a lower surface of the hooking layer. After heat treatment, top ends of the raised monofilaments are molten and softened to form small bumps, at the same time, the monofilaments have a certain curvature and inclination after heat treatment to form hooks so as to be hooked to the gaps of various adhesive anti-slip layers below and form a locking effect, short hooks may also be hooked, and the monofilaments do not need to extend too deeply into the hooking-connecting face layer 3, and the adhesive anti-slip layer may be further thinner. During use, the force on the surface layer will compress the carpet mat, which causes the hooks formed by the raised monofilaments on the surface layer to enter the adhesive anti-slip layer, resulting in a better hooking effect compared with non-bent monofilaments. The raised monofilaments are distributed on a back of the surface layer, which will not damage the surface layer during the disassembly process and has a long service life. Compared with the hooks being distributed on an upper surface of the adhesive anti-slip layer, it can be applied to an ultra-thin carpet mat surface and gives people a different touch. The raised monofilaments of the present disclosure will not pierce the surface layer, nor affect the use feeling. When replacing the surface layer on a large area, the adhesive anti-slip layer as a base may be reserved and used as a carpet mat for subsequent laying of the surface layer, the bumps all over a surface of the base will not prickle the hands, nor affect the replacement of the surface layer on the adhesive anti-slip layer.

### Embodiment 2

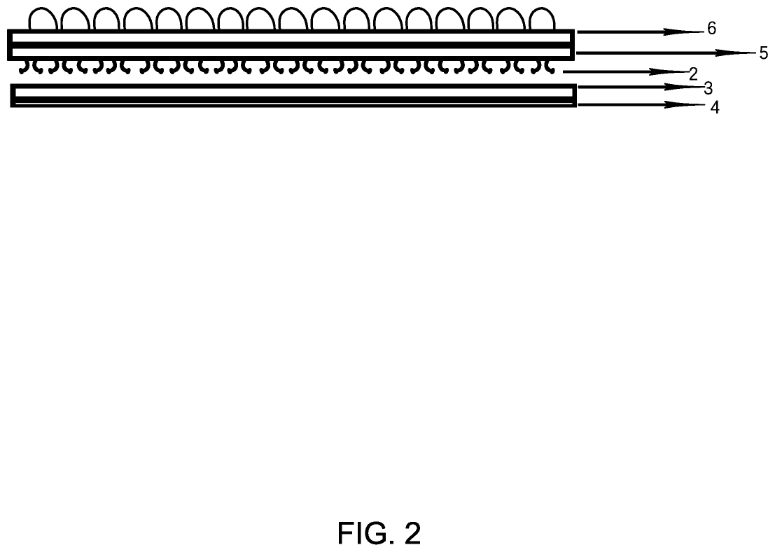

As shown in FIG. 2, the surface layer includes a single-sided fleece structure layer 6, a hooking layer 2 and a fabric binding layer 5. The single-sided fleece structure layer 1 is connected to the fabric binding layer 5 through glue, then the fabric binding layer 5 and the hooking layer 2 are connected through glue, and the adhesive anti-slip layer includes the hooking-connecting face layer 3 and the first anti-slip layer 4. The single-sided fleece structure layer 6 is arranged on at a top end of the surface layer, and the hooking-connecting face layer 3 is bonded to a top end of the first anti-slip layer 4. Raised monofilaments are distributed on a lower surface of the hooking layer. After heat treatment, top ends of the raised monofilaments are molten and softened to form small bumps, at the same time, the monofilaments have a certain curvature and inclination after heat treatment to form hooks so as to be hooked to the gaps of various adhesive anti-slip layers below and form a locking effect, short hooks may also be hooked, and the monofilaments do not need to extend too deeply into the hooking-connecting face layer 3, and the adhesive anti-slip layer may be further thinner. During use, the force on the surface layer will compress the carpet mat, which causes the hooks formed by the raised monofilaments on the surface layer to enter the adhesive anti-slip layer, resulting in a better hooking effect compared with non-bent monofilaments. The raised monofilaments are distributed on a back of the surface layer, which will not damage the surface layer during the disassembly process and has a long service life. Compared with the hooks being distributed on an upper surface of the adhesive anti-slip layer, it can be applied to an ultra-thin carpet mat surface and gives people a different touch. The raised monofilaments of the present disclosure will not pierce the surface layer, nor affect the use feeling. When replacing the surface layer on a large area, the adhesive anti-slip layer as a base may be reserved and used as a carpet mat for subsequent laying of the surface layer, the bumps all over a surface of the base will not prickle the hands, nor affect the replacement of the surface layer on the adhesive anti-slip layer.

### Embodiment 3

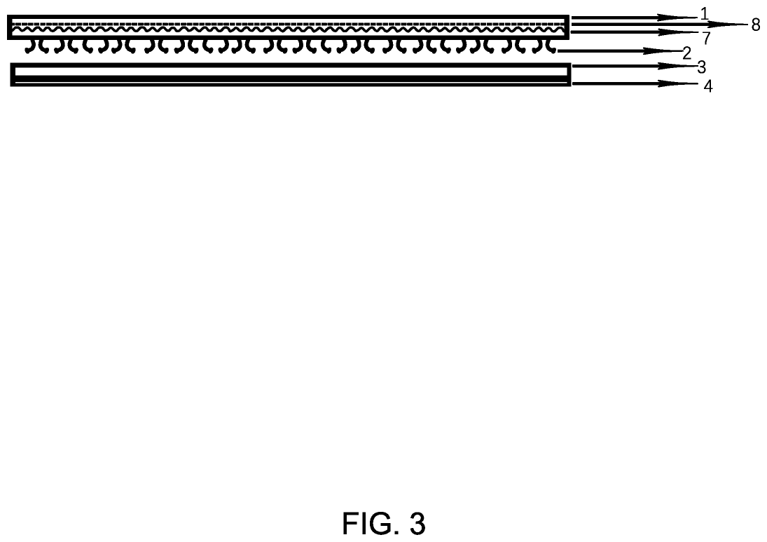

As shown in FIG. 3, the surface layer includes a plain woven structure face layer 1, a non-woven fabric layer 8, a mid-cotton layer 7 and a booking layer 2. The plain woven structure face layer 1, the non-woven fabric layer 8, the mid-cotton layer 7 and the hooking layer 2 are connected in a quilting seam mode. The adhesive anti-slip layer includes a hooking-connecting face layer 3 and a first anti-slip layer 4. The hooking-connecting face layer 3 and the first anti-slip layer 4 are connected with glue. Raised monofilaments are distributed on a lower surface of the hooking layer. After heat treatment, top ends of the raised monofilaments are molten and softened to form small bumps, at the same time, the monofilaments have a certain curvature and inclination after heat treatment to form hooks so as to be hooked to the gaps of various adhesive anti-slip layers below and form a locking effect, short hooks may also be hooked, and the monofilaments do not need to extend too deeply into the hooking-connecting face layer 3, and the adhesive anti-slip layer may be further thinner. During use, the force on the surface layer will compress the carpet mat, which causes the hooks formed by the raised monofilaments on the surface layer to enter the adhesive anti-slip layer, resulting in a better hooking effect compared with non-bent monofilaments. The raised monofilaments are distributed on a back of the surface layer, which will not damage the surface layer during the disassembly process and has a long service life. Compared with the hooks being distributed on an upper surface of the adhesive anti-slip layer, it can be applied to an ultra-thin carpet mat surface and gives people a different touch. The raised monofilaments of the present disclosure will not pierce the surface layer, nor affect the use feeling. When replacing the surface layer on a large area, the adhesive anti-slip layer as a base may be reserved and used as a carpet mat for subsequent laying of the surface layer, the bumps all over a surface of the base will not prickle the hands, nor affect the replacement of the surface layer on the adhesive anti-slip layer.

What is claimed is:

1. A detachable carpet mat, comprising a surface layer, an adhesive anti-slip layer and a carpet surface layer, wherein the carpet surface layer and the adhesive anti-slip layer are detachably connected;
the surface layer comprises: a plain woven structure face layer (1) and a hooking layer (2), wherein the plain woven structure face layer (1) is arranged at a top end of the surface layer; and
raised monofilaments are distributed on a lower surface of the hooking layer (2), the monofilaments have a certain curvature and inclination after heat treatment to form hooks, and the hooks are used for being hooked to gaps of various adhesive anti-slip layers (9) below and forming a locking effect.

2. The detachable carpet mat according to claim 1, wherein the plain woven structure face layer (1) comprises a fleece fabric structure layer, a woven fabric layer with a mesh gap structure, a fabric structure layer with several gaps, a non-woven structure layer and an air layer sandwich structure layer.

3. The detachable carpet mat according to claim 1, wherein the adhesive anti-slip layer comprises: a hooking-connecting face layer (3) and a first anti-slip layer (4), wherein the first anti-slip layer (4) is arranged at a bottom of the adhesive anti-slip layer.

4. The detachable carpet mat according to claim 3, wherein the hooking-connecting face layer (3) and the first anti-slip layer (4) are combined by glue or flame.

5. The detachable carpet mat according to claim 1, wherein a material of the adhesive anti-slip layer adopts a thermoplastic elastomer layer and/or an EVA/PU/PVC/SBR/XPE foam material layer and/or a non-woven fabric layer and/or a hot melt glue layer.

6. The detachable carpet mat according to claim 3, wherein a supportive fabric structure layer is placed between the hooking-connecting face layer (3) and the first anti-slip layer (4).

7. The detachable carpet mat according to claim 1, wherein a height of the raised monofilament is 0.5 mm to 5 mm, and a thickness of the raised monofilament is 20DTEX to 5000DTEX.
